(19) United States
(12) Patent Application Publication
(10) Pub. No.: US 2015/0047358 A1
(43) Pub. Date: Feb. 19, 2015

(54) INNER BARREL MEMBER WITH INTEGRATED DIFFUSER FOR A GAS TURBOMACHINE

(71) Applicant: General Electric Company, Schenectady, NY (US)

(72) Inventors: Carl Gerard Schott, Simpsonville, SC (US); Kenneth Damon Black, Travelers Rest, SC (US); Matthew Stephen Casavant, Atlanta, GA (US)

(73) Assignee: General Electric Company, Schenectady, NY (US)

(21) Appl. No.: 13/966,667

(22) Filed: Aug. 14, 2013

(51) Int. Cl. F23R 3/16; F02C 3/14

(52) U.S. Cl. CPC F23R 3/16; F02C 3/14
USPC 60/726; 60/722

(57) ABSTRACT

An inner barrel member for a gas turbomachine includes a body having an outer surface, an inner surface and one or more radial flow splitters provided on the outer surface. The one or more radial flow splitters are configured and disposed to be arranged along a combustor centerline at a combustion flow outlet radially inwardly of a transition piece.

### BACKGROUND OF THE INVENTION

The subject matter disclosed herein relates to the art of turbomachines and, more particularly to an inner barrel member with an integrated diffuser for a gas turbomachine.

In general, gas turbine engines combust a fuel/air mixture that releases heat energy to form a high temperature gas stream. The high temperature gas stream is channeled to a turbine portion via a hot gas path. The turbine portion converts thermal energy from the high temperature gas stream to mechanical energy that rotates a turbine shaft. The turbine portion may be used in a variety of applications, such as for providing power to a pump or an electrical generator or other mechanical device.

### BRIEF DESCRIPTION OF THE INVENTION

According to one aspect of an exemplary embodiment, an inner barrel member for a gas turbomachine includes a body having an outer surface, an inner surface and one or more radial flow splitters provided on the outer surface. The one or more radial flow splitters are configured and disposed to be arranged along a combustor centerline at a combustion flow outlet radially inwardly of a transition piece.

According to another aspect of the exemplary embodiment, a gas turbomachine includes a compressor portion having a first inner casing and a second inner casing, and a turbine portion mechanically linked to the compressor portion. A combustor assembly includes a plurality of combustors that fluidically connect the compressor portion and the turbine portion. Each of the plurality of combustors includes a transition piece. An inner barrel member mechanically and fluidically connects the first inner casing and the second inner casing. The inner barrel member includes a body having an outer surface, an inner surface, and one or more radial flow splitters provided on the outer surface. Each of the one or more radial flow splitters is arranged along a combustor centerline of one of the plurality of combustors radially inwardly of the transition piece of one or more of the combustors.

In accordance with yet another exemplary embodiment, a gas turbomachine system includes a compressor portion having a first inner casing and a second inner casing, an intake system fluidically connected to the compressor portion, a turbine portion mechanically linked to the compressor portion, and an exhaust system fluidically connected to the turbine portion. A driven member is mechanically linked to the compressor portion and the turbine portion and a combustor assembly including a plurality of combustors fluidically connects the compressor portion and the turbine portion. Each of the plurality of combustors includes a transition piece. An inner barrel member mechanically and fluidically connects the first inner casing and the second inner casing. The inner barrel member includes a body including an outer surface and an inner surface and one or more radial flow splitters provided on the outer surface. Each of the one or more radial flow splitters is arranged along a combustor centerline of one of the plurality of combustors radially inwardly of the transition piece of one or more of the combustors.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional schematic representation of a gas turbomachine including an inner barrel member, in accordance with an exemplary embodiment;

FIG. 2 is a partial perspective view of the inner barrel member of FIG. 1 illustrating a radial flow splitter, in accordance with the exemplary embodiment;

FIG. 3 is a perspective view of the radial flow splitter of FIG. 2;

FIG. 4 is a side plan view of the radial flow splitter of FIG. 2; and

FIG. 5 is a top plan view of the radial flow splitter of FIG. 2.

The detailed description explains embodiments of the invention, together with advantages and features, by way of example with reference to the drawings.

### DETAILED DESCRIPTION OF THE INVENTION

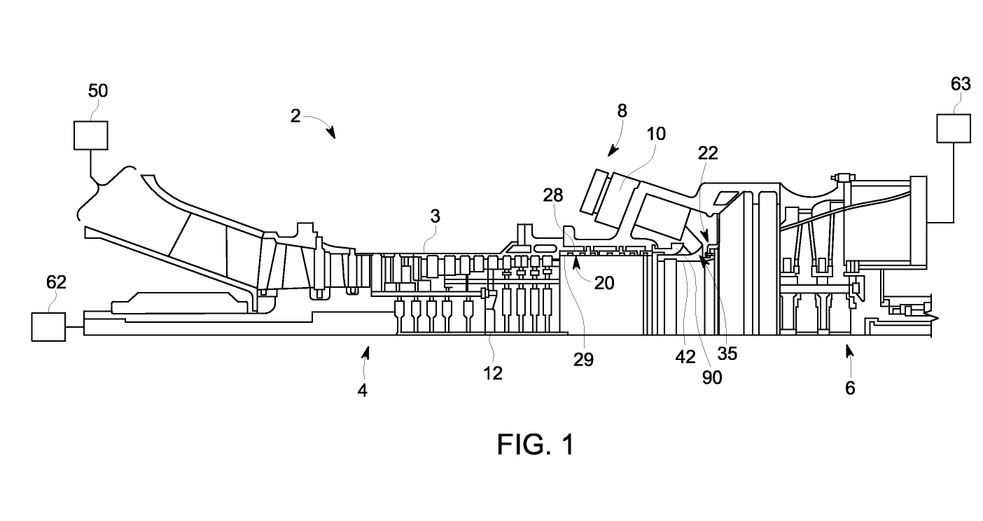

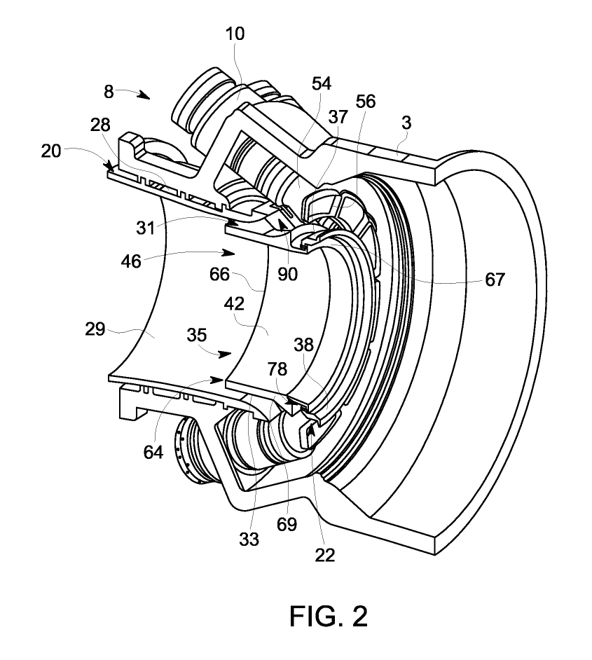

A turbomachine, in accordance with an exemplary embodiment, is indicated generally at 2 in FIG. 1. Turbomachine 2 includes an outer shell 3 that houses a compressor portion 4 and a turbine portion 6. Compressor portion 4 is fluidically connected to turbine portion 6 through a combustor assembly 8. Combustor assembly 8 includes a plurality of combustors 10. Compressor portion 4 and turbine portion 6 are mechanically linked through a common compressor/turbine shaft 12. As shown in FIG. 2, compressor portion 4 includes a first or forward inner casing 20 and a second or aft inner casing/support ring 22. Forward inner casing 20 includes an outer surface 28 that is connected to outer shell 3 and an inner surface 29.

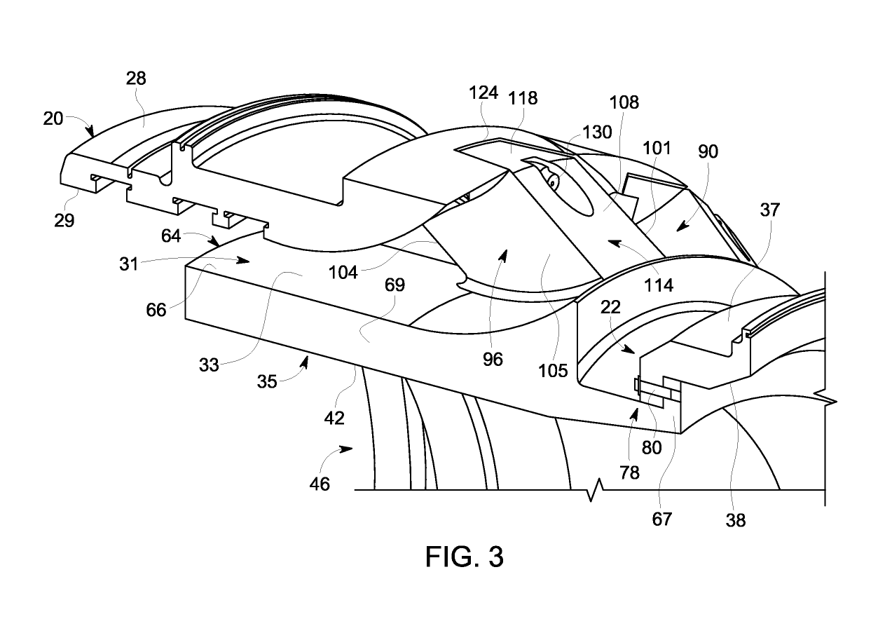

As shown in FIG. 2, a first compressor airflow path 31 is defined between inner surface 29 of inner casing 20 and an outer surface 33 of an inner barrel member 35. Compressor discharge air moves through airflow path 31 and is reduced in velocity by a diffuser section (not separately labeled) before moving between and around combustors 10 as will be detailed more fully below. Aft inner casing 22 includes an outer surface 37 and an inner surface 38. An inner surface 42 of inner barrel member 35 and inner surface 34 of aft inner casing 22 define a second flow path portion 46 (FIG. 3) that delivers cooling air from compressor portion 4 into a wheelspace (not separately labeled) of turbine portion 6.

Air enters into compressor portion 4 through an intake system 50 (FIG. 1) fluidically connected to compressor portion 4 and is compressed through a number of stages (not separately labeled). A portion of compressed air moves over inner barrel member 35, through first airflow path 31, then around and between transition pieces 54 (FIG. 2) of combustors 10. A portion of the compressed air enters combustors 10 to mix with fuel to form a combustible mixture. The combustible mixture is combusted forming hot gases. The hot gases are passed from a combustion flow outlet 56 of each transition piece 54 into turbine portion 6. The hot gases drive blade members (not separately labeled) in turbine portion 6 converting thermal energy into mechanical energy that rotates shaft 12. The mechanical energy passes through shaft 12 to drive an external component 62 (FIG. 1) which may include a pump, a generator or the like. The hot gases pass from turbine portion 6 through an exhaust system 63. Exhaust system 63 may treat the exhaust gases to lower emissions. Additional airflow from compressor portion 4 flows along the second flow path portion 46 into the wheelspace for cooling purposes.

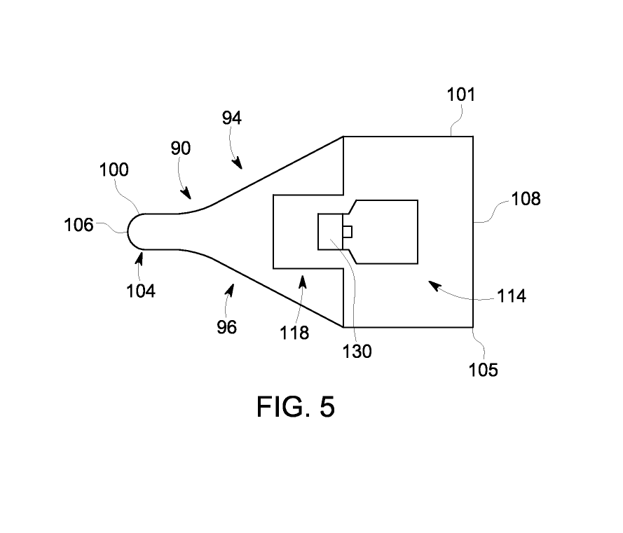

As best shown in FIGS. 3-5, inner barrel member 35 includes a body 64 that extends between a first or upstream end 66 and a second or downstream end 67 through an intermediate portion 69. Intermediate portion 69 includes outer surface 33 and an inner surface 42. Downstream end 67 is joined to aft inner casing 22 through a bolted joint 78 by one or more mechanical fasteners 80. Inner barrel member 35 includes a plurality of radial flow splitters, one of which is indicated at 90, on outer surface 33. Radial flow splitters 90 are arranged along a centerline of each combustor 10. More specifically, each radial flow splitter 90 is arranged radially inwardly of a corresponding transition piece 54 along a centerline of each combustor 10. Radial flow splitters 90 are wedge-shaped so as to guide the airflow passing from the compressor below and between combustors 10 and, more specifically between gaps (not separately labeled) formed between adjacent transition pieces 54. As will be discussed more fully below, radial flow splitters 90 are shaped to cause a velocity reduction in the airflow passing from the compressor prior passing between transition pieces 54.

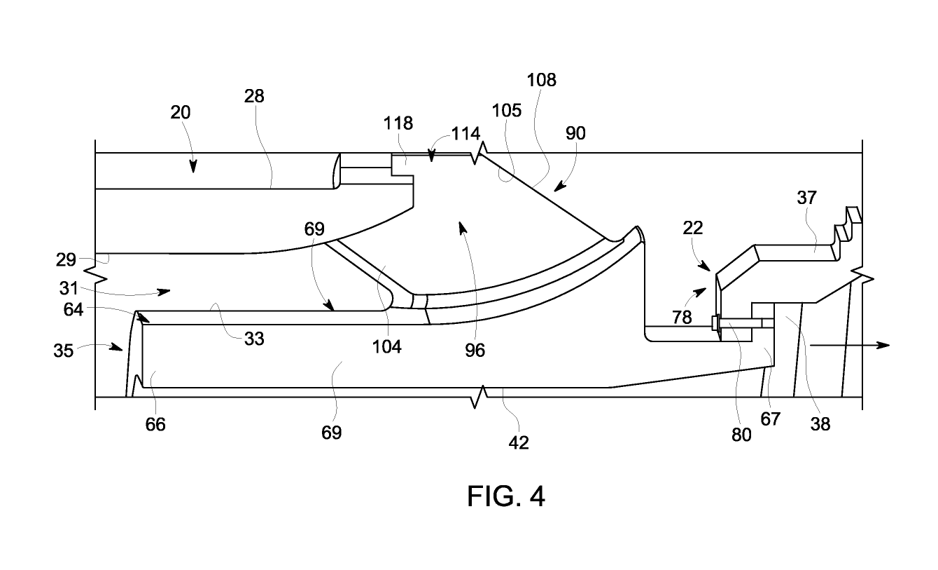

In accordance with an aspect of the exemplary embodiment, each radial flow splitter 90 is materially, integrally formed with outer surface 33 of inner barrel member 35. However, it should be understood that radial flow splitters 90 may also be attached to outer surface 33. As shown in FIG. 4, each radial flow splitter 90 includes a first tapered or curvilinear surface 94 and a second tapered or curvilinear surface 96. First tapered surface 94 extends from a first or upstream end 100 to a second or downstream end 101. Similarly, second tapered surface 96 extends from a first or upstream end 104 to a second or downstream end 105. Upstream end 100 is joined to upstream end 104 through an upstream end wall 106 having a first dimension (not separately labeled). The first and second tapered surfaces 94 and 96 cause a velocity reduction in the airflow to achieve a flow diffusion. Downstream end 101 of first tapered surface 94 is joined to downstream end 105 of second tapered surface 96 through a downstream end wall 108 having a second dimension (also not separately labeled). In accordance with an aspect of the exemplary embodiment, the second dimension of downstream end wall 108 is greater than the first dimension of upstream end wall 106. In the exemplary embodiment shown, end wall 108 is provided with a mounting member 114. Mounting member 114 may take the form of a rabbet 118 that nests within a mounting feature 124 provided on forward inner casing 20. Mounting member 114 is secured to forward inner casing 20 through a mechanical fastener 130. Mounting member 114 provides a forward support for inner barrel member 35.

At this point it should be understood that the exemplary embodiments describe an inner barrel member having radial flow splitters including tapered surfaces that guide compressor air between adjacent transition piece outlets into products of combustion passing from each combustor. Integrating flow splitters into the inner barrel member creates a more favorable flow field about the combustors, enhances combustion dynamics, improves performance, and reduces emissions. Further, the incorporation of radial flow splitters to the inner barrel member enables a turbomachine having a shorter diffusing section, to exhibit performance characteristics of longer turbomachine. Moreover, aligning the radial flow splitters with a centerline of each combustor promotes more complete mixing of compressed air passing between adjacent combustors and products of combustion exiting each transition piece outlet. It should also be understood that there need not be a radial flow splitter associated with each transition piece.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An inner barrel member for a gas turbomachine comprising:
a body including an outer surface and an inner surface, and one or more radial flow splitters provided on the outer surface, the one or more radial flow splitters being configured and disposed to be arranged along a combustor centerline radially inwardly of a transition piece.

2. The inner barrel member for a gas turbomachine according to claim 1, wherein the body extends from a first end to a second end through an intermediate portion, the second end being joined to an aft inner casing of the gas turbomachine.

3. The inner barrel member for a gas turbomachine according to claim 1, wherein each of the one or more radial flow splitters includes a first tapered surface and a second tapered surface that guide compressor air through gaps formed between adjacent transition pieces.

4. The inner barrel member for a gas turbomachine according to claim 3, wherein the first tapered surface extends from a first upstream end to a first downstream end and the second tapered surface extends from a second upstream end and a second downstream end, the first downstream end being joined to the second downstream end through an end wall provided with a mounting member.

5. The inner barrel member for a gas turbomachine according to claim 4, wherein the mounting member comprises a rabbet configured and disposed to inter-engage with a mounting feature provided on an upstream inner casing of the gas turbomachine.

6. The inner barrel member for a gas turbomachine according to claim 1, wherein each of the one or more radial flow splitters is materially, integrally formed with the outer surface.

7. A gas turbomachine comprising:
a compressor portion including a first inner casing and a second inner casing;
a turbine portion mechanically linked to the compressor portion;
a combustor assembly including a plurality of combustors fluidically connecting the compressor portion and the turbine portion, each of the plurality of combustors including a transition piece; and
an inner barrel member mechanically and fluidically connecting the first inner casing and the second inner casing, the inner barrel member comprising:
a body including an outer surface and an inner surface and one or more radial flow splitters provided on the outer surface, each of the one or more radial flow splitters being arranged along a combustor centerline of one of the plurality of combustors radially inwardly of the transition piece of one or more of the combustors.

8. The gas turbomachine according to claim 7, wherein the body extends from a first end to a second end through an intermediate portion, the second end being joined to the second inner casing through a bolted joint.

9. The gas turbomachine according to claim 7, wherein each of the one or more radial flow splitters includes a first tapered surface and a second tapered surface that guide compressor air through gaps formed between adjacent transition pieces.

10. The gas turbomachine according to claim 9, wherein the first tapered surface extends from a first upstream end to a first downstream end and the second tapered surface extends from a second upstream end to a second downstream end, the first downstream end being joined to the second downstream end through an end wall provided with a mounting member.

11. The gas turbomachine according to claim 10, wherein the first inner casing includes a mounting feature, the mounting member comprising a rabbet that inter-engages with the mounting feature.

12. The gas turbomachine according to claim 7, wherein each of the one or more radial flow splitters is materially, integrally formed with the outer surface.

13. The gas turbomachine according to claim 7, wherein the one or more radial flow splitters is arranged radially inwardly of the one of the plurality of combustors at the combustion flow outlet.

14. A gas turbomachine system comprising:
a compressor portion including a first inner casing and a second inner casing;
an intake system fluidically connected to the compressor portion;
a turbine portion mechanically linked to the compressor portion;
an exhaust system fluidically connected to the turbine portion;
a driven member mechanically linked to the compressor portion and the turbine portion;
a combustor assembly including a plurality of combustors fluidically connecting the compressor portion and the turbine portion, each of the plurality of combustors including a transition piece; and
an inner barrel member mechanically and fluidically connecting the first inner casing and the second inner casing, the inner barrel member comprising:
a body including an outer surface and an inner surface and one or more radial flow splitters provided on the outer surface, each of the one or more radial flow splitters being arranged along a combustor centerline of one of the plurality of combustors radially inwardly of the transition piece of one or more of the combustors.

15. The gas turbomachine system according to claim 14, wherein the body extends from a first end to a second end through an intermediate portion, the second end being joined to the second inner casing through a bolted joint.

16. The gas turbomachine system according to claim 14, wherein each of the one or more radial flow splitters includes a first tapered surface and a second tapered surface that guides compressor air through gaps formed between adjacent transition pieces.

17. The gas turbomachine system according to claim 16, wherein the first tapered surface extends from a first upstream end to a first downstream end and the second tapered surface extends from a second upstream end to a second downstream end, the first downstream end being joined to the second downstream end through an end wall provided with a mounting member.

18. The gas turbomachine system according to claim 17, wherein the first inner casing includes a mounting feature, the mounting member comprising a rabbet that inter-engages with the mounting feature.

19. The gas turbomachine system according to claim 14, wherein each of the one or more radial flow splitters is materially, integrally formed with the outer surface.

20. The gas turbomachine system according to claim 14, wherein the one or more radial flow splitters is arranged radially inwardly of the one of the plurality of combustors at the combustion flow outlet.
